(19) United States
(12) Patent Application Publication
(10) Pub. No.: US 2013/0135718 A1
(43) Pub. Date: May 30, 2013

(54) Multifunctional Imitation Displayer

(71) Applicant: Ming-Lai Wu, New Taipei City (TW)

(72) Inventor: Ming-Lai Wu, New Taipei City (TW)

(21) Appl. No.: 13/304,537

(22) Filed: Nov. 25, 2011

(51) Int. Cl. G03B 21/56

(52) U.S. Cl. 359/443

(57) ABSTRACT

A multifunctional imitation displayer comprises a projection screen, which is a fine and even lattice structure closely woven from twist yarns made from extremely fine single yarns and ultra-thin metal fibers through up-and-down weave; out-covering gray scale glass panels, which are transparent with high strength and hardness, and which are fixed on and tightly cover and seal the two sides of the projection screen by means of vacuum suction, and sealed on the edges; based on such a design, both front or back projection can obtain Full-HD imaging with superior depth, and the low manufacturing cost is suitable for mass production. When not used for projection, it can also be used as a white board for drawing with a colored pen and the user can wipe out the drawings and draw repeatedly.

### BACKGROUND OF INVENTION

1. Field of the Invention

The present invention relates generally to the projection screen structure of an imitation displayer, and more particularly to a multifunctional imitation displayer, which is a combination of a fine latticed screen made of special materials through up-and-down weave and the out-covering gray scale glass to project Full-HD and highly dimensional images and to meet different projection needs of various kinds of high or low-grade projectors for the screen.

2. Description of Related Art

There are numerous kinds of prior-art displayers. The following is a. brief description of their structures and an analysis of their advantages and disadvantages:
(1) Cathode Ray Tube Displayers (C.R.T.): In a C.R.T. displayer, a kinescope (electronic gun) emits high-speed electrons, which hit on the phosphate fluorescent layer on the screen to make it glow, and through adjustment of the voltage, various graphics and texts are shown on the screen. Such displayers feature saturated colors and sharp contrast, but also high energy consumption. Generation of radiation and heat is their critical disadvantage. Also, they are heavy and bulky, and consume a lot of electricity.
(2) Digital Light Processing Displayer (D.L.P.): a projector is installed inside the television, and the videos are generated through the bulb, light collecting lens and precise chip reflection. Such displayers feature gentle display, low heat generation and radiation, but are thick, heavy and expensive. And the bulb has a lifecycle problem.
(3) Liquid Crystal Displayer (L.C.D.), which is the mainstream of the current market of displayers. Its main component is the liquid crystal board, and the display relies on the electrical optical effect and polarizing property of the liquid crystal. Such displayers are light, consume less electric power and are of smaller sizes. However, when exceeding the practical visual range, the scenes cannot be completely displayed. When using such displayers, they have the dead watching angle problem.
(4) Plasma Display Panel (P.D.P.). In such a displayer, inert gas or mercury vapor is filled into a vacuum glass tube, and through increase of voltage, the gas will emit ultra-violet light through the plasma effect, which stimulates the phosphors to glow. Such displayers are light and thin, but bulky. They have good saturation and contrast, and have no dead watching angle problem; however, such products are expensive, highly energy-consuming and will easily generate heat when displaying.
(5) Light Emitting Diode Displayer (L.E.D.). The displaying screen is made up of LEDs. Each dot is one or more LEDs. Their lighting is controlled by the electric circuit, and the graphics shown on the big screen is reflected through the glowing or extinguishment of the different dots. Such displayers are bigger than L.C.D. displayers, and the image quality is just so-so. Their advantages are: good single color displaying, long lifecycle, high efficiency, low power consumption, and light weight; their disadvantages are: plane illumination, limited visual angle, low brightness, high production cost, low chemical stability, and susceptibility to temperature.

Moreover, regarding the competitive products of LCD, plasma and LIED displayers in the current market, their different production processes will affect their popularization, as briefed below:
(1) The production processes of LCD displayers will generate materials hazardous to human body, the waste gas discharge will also hurt the environment, and particularly, recovery and recycling is very difficult.
(2) Production of Plasma displayers requires considerable investment (more than 100 million NTD) in manufacturing equipment, and regular maintenance and disposal of discharges are also costly. Due to the enormous investment of resources in the production facility, which are not economical, the unit price of such products is naturally high.
(3) The diodes used in producing LED displayers have the advantage of long lifecycle, but the related components do not match very well, and therefore the result is not as good as expected. Particularly, mass production of large-size LED displayers is virtually impossible.

Based on the above brief introductions, it is obvious that all the products in the current market with relatively higher market shares or even the mainstream products have their respective shortcomings, and need to be improved.

Moreover, people are currently getting more and more demanding in video display. Although small-size displayers can already provide Full-HD graphic effect, they are limited to small screens. Therefore, the picture quality of displaying equipment with combination of a projector and a projection screen is now becoming a priority in industrial development. From earlier mono-functional projectors projecting directly on a white wall or with combination of a simple curtain, to multi-functional projectors with combination of special projection screens, all the developments are focused on improvement of picture quality to avoid image distortion. Such special displaying screens dedicated to projectors seen in the current market can be roughly divided into woven screens and elastic screens based on the materials used. Woven screens are made of woven cloth with a paint coating, and based on the different paints used, can be divided into white screens, grey screens and pearlescent screens. The latitude and longitude patterns inherent to woven materials will often cause low resolution of the images displayed, and the Moire effect when using in combination with a projector will affect the displaying effect. Of course, fine woven screens will have better image displaying effect; Elastic screens are mainly of plastic and PVC material with fine irregular pressed patterns to diffuse the light beams and improve the visual angle problem and image evenness. Elastic screens can be divided into white plastic screens, grey plastic screens, glass-beaded screens, metal screens, etc. Along with the deviation of projector functions toward different aspects, the projection screens can be further divided into reflection type and transmission type based on their different functions. The reflection type is used for front projection, while the transmission type is for back projection.

Based on the above-described prior-art projection screen structures, the users need to select a projector and screen based on their specific requirements; For example, when there are few people, they can choose a metal screen with smaller visual angle but higher gain in order to obtain satisfying projection images; when there are many people, they can choose a white plastic screen with larger visual angle but lower gain to obtain a projection effect for many viewers. However, any of the screen structures has their respective advantages and disadvantages, and cannot be widely used to meet the different requirements of the projectors for screens. For example, the white plastic screens have a wide visual angle but the brightness is not sufficient, the reflection is poor, the projection image may easily get blurred, and the gradation and 3D effect of the image is not good enough; Glass-beaded screens are coated with a layer of optical glass beads to provide high brightness and reflection, but may easily generate glare and dazzle. Also, the uneven coating of the glass beads may cause non-uniform reflection. Particularly, the spraying of chemicals during the production may easily cause air pollution, and the disuse may also cause secondary pollution. Other projection screens also have various problems, for example: the screen cannot be absolutely flat; or only one side can be used; or there is radiation; or the screen cannot be washed in water; or the light absorption and reflection is not even; or the screen is heavier under similar specifications. With all such shortcomings, it is obvious that there is indeed a necessity to improve the prior-art projection screens.

In addition, currently the industry is developing a micro-projection technology featuring low consumption of energy, small size and low cost. The micro-projection technology mainly uses LED or laser as the backlight, which is enlarged through optical lens and projected on the screen to display the image. Because this technology is not completely mature, the picture quality cannot reach the level of ordinary displayers. Moreover, the LED projection technology is similar to the existing LED displayers, the investment in manufacturing equipment is enormous, and there is still an environmental problem to dispose the discharges. Therefore, the project is not suitable for small and medium-sized manufacturers. Laser projection is similar to the image scanning technology. Without the need for focused imaging, the laser projection technology can be applied in a non-flat surface and produce images without the need to adjust the focal distance. And due to its simple structure is simple, the production cost is lower than the LED projection technology. In spite of its multiple advantages, few commercial products are seen in the current market. The main problem is lack of small-sized, low energy-consuming, high-power blue laser in the market, and also the difficulty to effectively remove the laser facular caused by the homological property of the laser beam. Hence, based on the current existing projection technology, to provide image quality comparable to displayers, the projection screen is well positioned in the market.

In view of the above, the present inventor carried out numerous experiments, tests and improvements in order to develop a product in the concept of a displayer based on imitation LCD, LED panels, which can show fine and sharp images with a high resolution, and which have maximum pixels within the same panel size, so that the images can have more details. Meanwhile, the inventor aimed to solve the various problems in manufacturing prior-art displayers: step-by-step development, massive investment, environment-hazardous processes, and generation of considerable hazardous wastes during recovery to cause ecological disasters. Through great efforts, the present inventor finally invented a “multifunctional imitation displayer”, which can provide not only Full-HD imaging effect reaching 4K×2K resolution, but also better imaging depth than ordinary flat displayers. Moreover, there is no problem of afterimage or lifecycle.

### SUMMARY OF THE INVENTION

Therefore, the first objective of the present invention is to provide a. multifunctional imitation displayer, through which, the projection can have Full-HD imaging effect (even reaching 4K×2K resolution), and good imaging depth.

The second objective of the present invention is to provide a multifunctional imitation displayer, which can alleviate the hurt to the eyes through design of the projection screen which does not emit but only absorbs light.

The third objective of the present invention is to provide a multifunctional imitation displayer, which requires low production investment and is suitable for mass production.

The fourth objective of the present invention is to provide a multifunctional imitation displayer, which can effectively save energy and have longer lifecycle because it does not need to powered and does not emit light. In case of damage of the out-covering gray scale glass panel, the waste disposal will not cause any environmental problems.

The fifth objective of the present invention is to provide a multifunctional imitation displayer, which, when not used as a projection screen, can be used for other purposes, for example, as a white board for meetings or teachings, so as to enhance the multi-functional utility of the displayer.

To accomplish the above objectives, the multifunctional imitation displayer invented by the present inventor comprises at least:

a projection screen, the structure of which is fine, even and closely woven from twist yarns made of extremely fine single yarns and ultra-thin metal fibers through up-and-down weave, having very each yarn;

two out-covering gray scale glass panels, which are transparent with high strength and hardness, and which are fixed on and tightly cover and seal the two sides of the projection screen by means of vacuum suction and sealing; based on such a design, in implementation, it can be used for both front and back projection according to the actual need, so as to provide Full-HD imaging quality even reaching 4K×2K resolution, and better imaging depth than ordinary flat displayers.

The above-described multifunctional imitation displayer can be further configured with a flexible base; one side of the flexible base can receive the projection screen, while the other side can be provided with a plurality of rolling wheels for movement flexibility.

The above-described multifunctional imitation displayer can be used as a white board when it is not used for projection. The user can directly draw on its surface using colored paintbrushes, and wipe out and draw repeatedly.

For the auditors to understand more about other objectives, features and advantages of the “multifunctional imitation displayer” of the present invention, its structural characteristics are described below in detail.

### BRIEF DESCRIPTION OF THE DRAWINGS

FIG. 1 is an exploded view of the multifunctional imitation displayer of the present invention.

FIG. 2 is an assembled view of the multifunctional imitation displayer of the present invention.

FIG. 3 is an exploded view of another embodiment of the multifunctional imitation displayer of the present invention.

FIG. 4 is an assembled view of another embodiment of the multifunctional imitation displayer of the present invention.

FIG. 5 depicts the front projection usage state of the multifunctional imitation displayer of the present invention.

FIG. 6 depicts the back projection usage state of the multifunctional imitation displayer of the present invention.

FIG. 7 depicts another usage state of the multifunctional imitation displayer of the present invention.

### DETAILED DESCRIPTION OF THE INVENTION

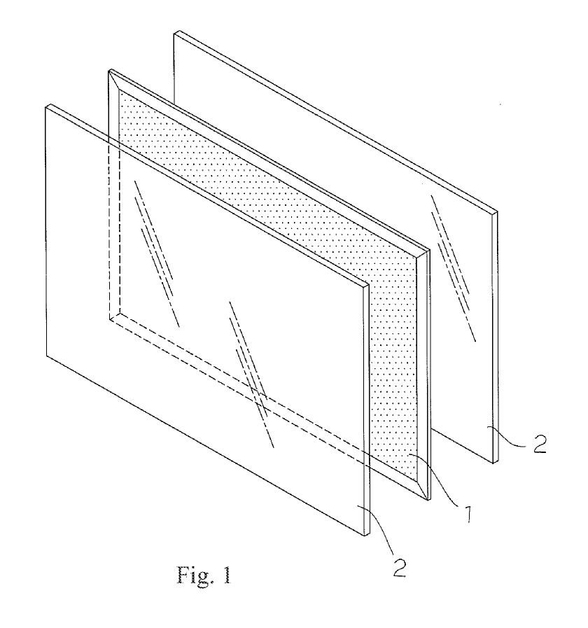

The present invention provides a multifunctional imitation displayer. Referring to FIG. 1, its structure comprises at least:

a projection screen 1, which is a fine and even yarn structure closely woven from special fibers through up-and-down weave, and the width and height proportions of which can be adjusted according to actual needs, including but not limited to the present common proportion of 4:3. In production, the projection screen 1 is not like common woven curtains. It uses twist yarn made of extremely fine single yarn and ultra-thin metal fibers, which are woven through plain up-and-down weave to make the surface extremely fine, and the spacing between each yarn is tight and even, so that the finished latticed projection screen 1 can be used on both sides for projection. Finally, the fabric is fixed through an electric net puller machine, and tested by instruments to ensure even tension, flat and ripple-free surface; and unlike the existing screens emit light, the finished projection screen 1 absorbs light.

Two out-covering gray scale glass panel 2, which are transparent with high strength and hardness. In implementation, they can be made of, but not limited to quartz glass, Low-E glass, etc, so as to avoid image distortion through the good transparency. The out-covering gray scale glass panels 2 are fixed on and tightly cover and seal the two sides of the projection screen 1 by means of vacuum suction, to ensure that no air bubbles will be generated during the covering, and after the covering, the edges are sealed to maintain smoothness of the projection screen 1.

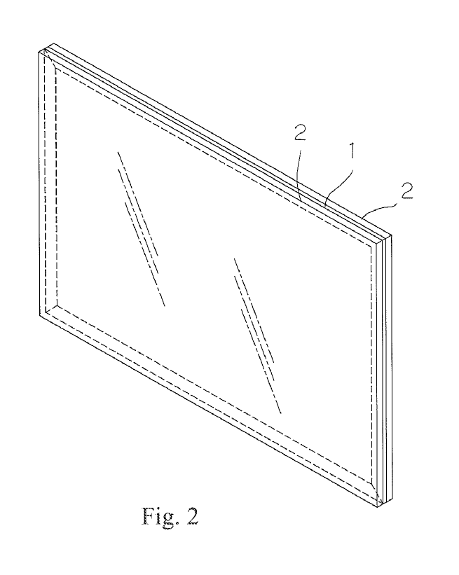

The above components constitute a complete and innovative multifunctional imitation displayer, as shown in FIG. 2.

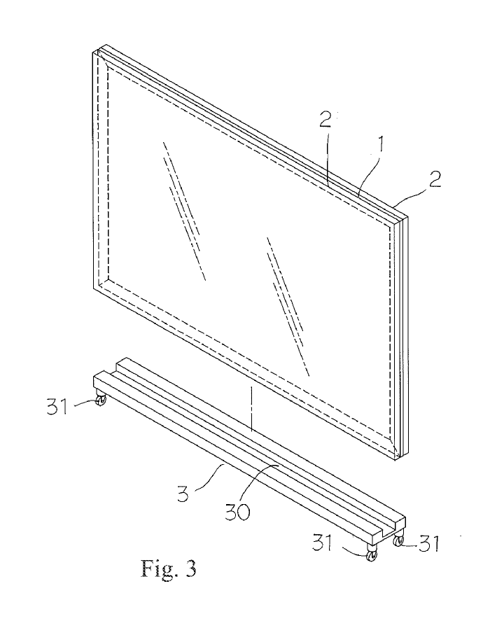

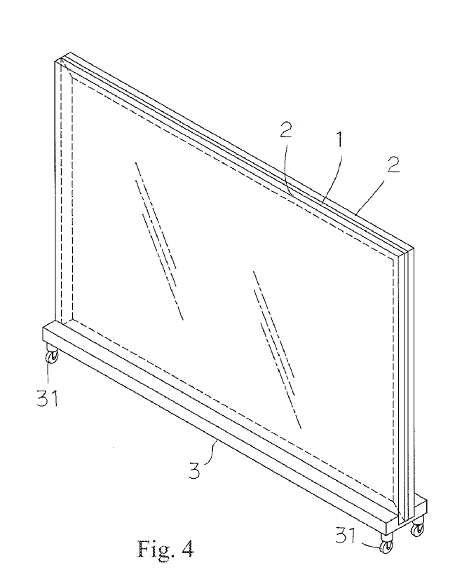

Referring to FIGS. 3 and 4, the above multifunctional imitation displayer is further configured with a flexible base 3; the flexible base 3 can be made of common materials, such as light metal, wood, plastics, etc, with a receiving groove 3( )on the surface for inserting and fixing the multifunctional imitation displayer. Its bottom side is configured with a plurality of rolling wheels 31 for movement flexibility, and to facilitate easy usage and storage.

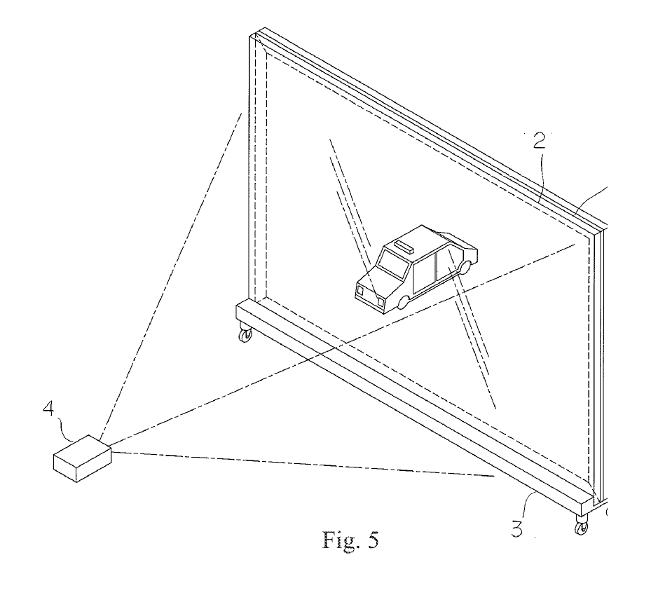

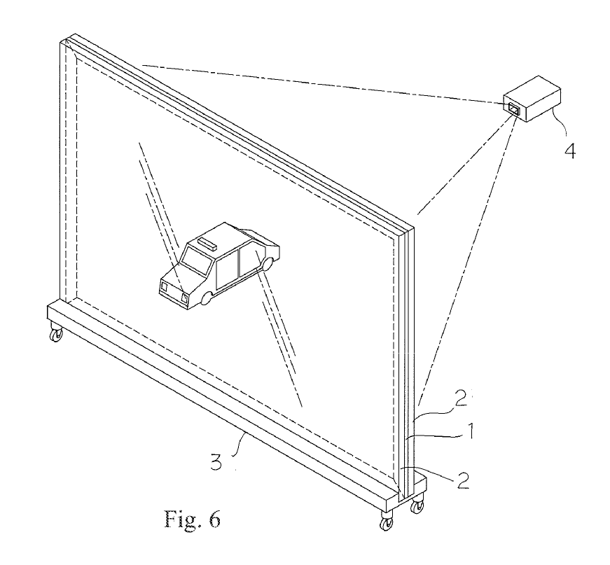

Referring to FIGS. 5 and 6, in actual usage, when a projector 4 projects on the above-described multifunctional imitation displayer, the images will be clearly, sharply, and completely reflected on the multifunctional imitation displayer; meanwhile, according to different needs of the users, it can be used for either front projection or back projection. In either application, it can provide Full-HD imaging effect up to 4K×2K resolution, and the imaging depth is better than flat-panel displayers.

As the projection screen 1 of the present invention contains metal fiber materials, and is covered and strengthened by two hard layers of gray scale glass panels 2, the projection screen 1 can maintain flatness and smoothness over a long period of time, free of ripples; meanwhile, the projection screen 1 is woven from high-density latitudinal and longitudinal yarns, which are distributed evenly with tight and fine spacing, ensuring even and smooth light absorption and reflection. Apart from a nice field of vision and a large visual angle, it can provide an outstanding projection effect with no bright spots, shadows or glares; further, through the tight joint of the out-covering gray scale glass panels 2 on both sides, the projection screen 1 can be easily stored, and can even be washed or wiped directly using water, without causing distortion of the screen or affecting its lifecycle.

Moreover, when the present invention is applied in actual projection, as the surface of the projection screen 1 is not subject to any additive or processing, both sides can be used for projection. This is obviously very convenient. When used for front projection, the display is complete and fine, and if the ambient light is bright, the backside can be covered with a black cloth; when used for back projection, the images can be directly projected on the projection screen 1, and the images will be clearly and completely reflected on the other side, without any need for an intensifying apparatus, and not affected by the location of the projector or the light source. This is a great convenience and an obvious improvement upon prior-art screens of which only one side can be used for projection. Furthermore, when the beams from the projector are projected on the projection screen 1, the above-described components and characteristics of the multifunctional projection screen will enhance the color saturation and contrast surpassing the standard values, without any need for additional special screen materials as used by prior-art woven screen curtains; particularly, the depth and 3D effect of images projected on the multifunctional imitation displayer are superior.

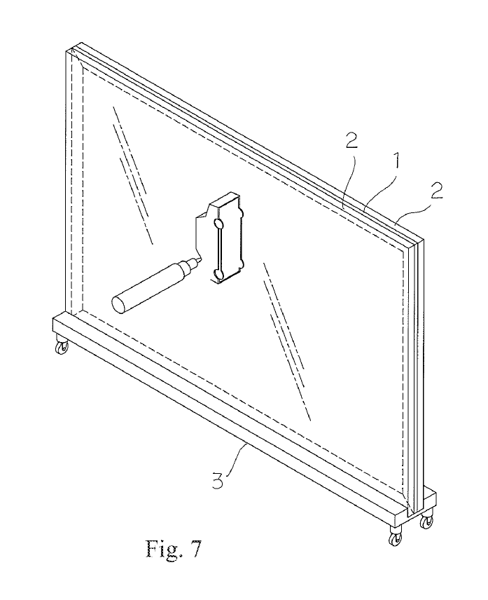

Finally, referring to FIG. 7, as both sides of the projection screen 1 of the present invention are covered and strengthen by high-strength and high-hardness out-covering gray scale glass panels 2, when not used for the purpose of projection, it can be used as a white board for meetings and teachings. The users can directly write on the screen with a colored pen, and wipe out and write repeatedly. Such a multi-functional property can obviously enhance the utility and practicability of the product.

To summarize, the improved projector screen structure of the present invention indeed has substantial efficacy improvements as described above and as proved in actual implementations. It not only solved the shortcomings of prior-art projection screens, but also surpassed the flat-panel displayers in Full-HD imaging up to 4K×2K resolution, with better depth and 3D effect. It has substantially surpassed the technological scope of existing displayers, and is an innovative and practical design. In view of the fact that this innovative design meets the prerequisites prescribed by the Patent Law, a patent application is hereby submitted.

Although the invention has been explained in relation to its preferred embodiment, it is to be understood that many other possible modifications and variations can be made without departing from the spirit and scope of the invention as hereinafter claimed.

1. A multifunctional imitation displayer, comprising:
a projection screen, which is a fine and even lattice structure closely woven from twist yarns made from extremely fine single yarns and ultra-thin metal fibers through up-and-down weave; and
two out-covering gray scale glass panel, which are transparent with high strength and hardness, and which are fixed on and tightly cover and seal the two sides of the projection screen by means of vacuum suction and sealing.

2. The multifunctional imitation displayer as claimed in claim 1, which further includes a flexible base, with a receiving groove on its surface, and a plurality of rolling wheels evenly distributed on its bottom.
